(19) United States
(12) Patent Application Publication
(10) Pub. No.: US 2026/0058459 A1
(43) Pub. Date: Feb. 26, 2026

(54) METHOD AND SYSTEM FOR CHECKING THE ABILITY OF AN ELECTRONIC FUSE TO SWITCH OFF

(71) Applicant: HELLA GMBH & CO. KGAA, Lippstadt (DE)

(72) Inventors: Daniel Klimeck, Bad Wuennenberg (DE); Christopher Lankeit, Paderborn (DE); Christoph Niessner, Paderborn (DE)

(21) Appl. No.: 19/304,985

(22) Filed: Aug. 20, 2025

(30) Foreign Application Priority Data
Aug. 23, 2024 (DE) 102024124225.6

(51) Int. Cl. H02H 3/24; H02H 1/00

(52) U.S. Cl. CPC H02H 3/24; H02H 1/0007

(57) ABSTRACT

The present invention relates to a method for checking the switch-off capability of an electronic fuse which is arranged between a voltage source and a consumer. The method includes monitoring a voltage at the consumer, switching the electronic fuse to a non-conductive state, and checking whether the voltage at the consumer drops to a threshold voltage within a set time. The present invention also relates to a system for checking the switch-off capability of an electronic fuse. The system includes a voltage source, a consumer, an electronic fuse between the voltage source and the consumer, a voltage measuring device to measure the voltage at the consumer, and a checking unit. The checking unit monitors the voltage at the consumer via the voltage measuring device, switches the electronic fuse to a non-conductive state, and checks whether the voltage at the consumer drops to a threshold voltage within a set time.

### CROSS-REFERENCE TO RELATED APPLICATIONS

The present application claims the benefit of German Patent Application No. 10-2024-124-225.6, filed Aug. 23, 2024, the disclosure of which is incorporated by reference.

### FIELD OF THE INVENTION

The present invention relates to a method and a system for checking the ability to switch off an electronic fuse arranged between a voltage source and a consumer.

### BACKGROUND OF THE INVENTION

Since it can happen with electronic fuses—for example due to a defect in a semiconductor switch typically installed in the electronic fuse—that the fuse does not open in the event of an overcurrent, i.e. remains conductive, it is advantageous when using an electronic fuse to regularly check whether the electronic fuse can be opened, i.e. switched non-conductive.

However, when using an electronic fuse in conjunction with a so-called always-on consumer, for example some critical control devices or sensors of a motor vehicle, it is not permitted to interrupt the voltage supply of the consumer to check the electronic fuse's ability to switch off.

Against this background, DE 10-2021-214-971 A1 discloses a method for checking the switch-off capability of an electronic fuse, wherein the electronic fuse comprises a MOSFET, and wherein it is checked whether a drain-source voltage of the MOSFET increases when a gate-source voltage of the MOSFET is reduced.

DE 10-2021-214-975A1 also discloses a system for checking the switch-off capability of an electronic fuse, wherein a second electronic fuse is connected in parallel with the electronic fuse to be checked, and wherein the second electronic fuse is switched to be conductive and the electronic fuse to be checked is switched to be non-conductive in order to check the switch-off capability.

### SUMMARY OF THE INVENTION

The present invention is based on the object of enabling a simple check of the switch-off capability of an electronic fuse, preferably without interrupting the voltage supply to a connected consumer.

This object is achieved in accordance with the invention by a method for checking the switch-off capability of an electronic fuse, and by a system for checking the switch-off capability of an electronic fuse.

The method according to the invention is used to check the switch-off capability of an electronic fuse which is arranged between a voltage source and the consumer to protect a consumer, preferably a so-called always-on consumer. Switch-off capability refers to the ability to safely disconnect an electrical connection between the voltage source and the consumer in the event of a critical event, such as an overcurrent.

In the method according to the invention, a voltage, or more precisely an electrical voltage, is monitored at the consumer in order to check the switch-off capability of the electronic fuse by means of a suitable voltage measuring device. The voltage at the consumer is preferably measured at high frequency, i.e. at particularly short intervals. It is also conceivable that a voltage at a consumer-side port of the electronic fuse is monitored to monitor the voltage at the consumer.

In the method according to the invention, the electronic fuse is switched to a non-conductive state to check the switch-off capability of the electronic fuse while the voltage at the consumer is being monitored, and it is checked whether or not the voltage at the consumer drops to a threshold voltage within a set time. The threshold voltage can be defined both as an absolute value and as a voltage delta with respect to a voltage at the consumer at the time of non-conductive switching or with respect to a supply voltage. If the voltage at the consumer drops to the threshold voltage within the set time, it is assumed that the electronic fuse is capable of switching off. If the voltage does not drop to the threshold voltage within the set time, it is assumed that the electronic fuse is not capable of switching off.

The method according to the invention thus enables a simple check of the switch-off capability of an electronic fuse.

Preferably, the electronic fuse is switched to conductive again when the voltage at the consumer has dropped to the threshold voltage or when a maximum test time has been reached since the electronic fuse was switched to non-conductive in order to avoid an interruption in the voltage supply to the consumer. The threshold voltage is preferably set in such a manner that the threshold voltage is sufficiently high to enable operation of the connected consumer. This makes it possible to use the method according to the invention to also check an electronic fuse used to protect a so-called always-on consumer.

Preferably, if the electronic fuse has been switched to conductive again because the maximum test time has been reached, i.e. if the voltage at the consumer has not dropped to the threshold voltage within the set time, a new check according to the invention is carried out, i.e. the voltage at the consumer is monitored again, the electronic fuse is switched to non-conductive again, and a new check is made as to whether or not the voltage at the consumer drops to the threshold voltage within the set time. It is preferable to carry out several new checks. This means that temporary interruptions to the switch-off capability of the electronic fuse can be ruled out and a permanent defect can be reliably detected.

The system according to the invention for checking the switch-off capability of an electronic fuse comprises a voltage source and a consumer which is supplied by the voltage source with the electrical energy required for the proper operation of the consumer. Preferably, the consumer is a so-called always-on consumer, i.e. a consumer whose voltage supply should not be interrupted.

The system according to the invention for checking the switch-off capability of an electronic fuse also comprises the electronic fuse to be checked. The electronic fuse is arranged between the voltage source and the consumer to protect the consumer, i.e. it is electrically connected to the voltage source on the input side and electrically connected to the consumer on the output side. The electronic fuse comprises one or more semiconductor switches, for example so-called MOSFETs or so-called IGBTs, which can be switched between a conductive state and a non-conductive state in a known manner via a control input.

The system according to the invention for checking the switch-off capability of an electronic fuse further comprises a voltage measuring device which is set up in a known manner to measure a voltage at the consumer directly or indirectly, for example by measuring the voltage at a port of the electronic fuse on the consumer side. The voltage measuring device is preferably set up to measure the voltage at the consumer at high frequency, i.e. at particularly short intervals.

The system according to the invention for checking the switch-off capability of an electronic fuse further comprises a checking unit which is set up to carry out a method according to the invention for checking the switch-off capability of the electronic fuse. In particular, the checking unit is therefore set up to monitor the voltage at the consumer by means of the voltage measuring device, to switch the electronic fuse to non-conductive, and to check whether or not the voltage at the consumer drops to a threshold voltage within a set time.

The system according to the invention thus enables a simple check of the switch-off capability of an electronic fuse for the reasons described above in relation to the method according to the invention.

Preferably, the checking unit is also set up to provide an error signal to a higher-level control unit if the result of the check is negative, i.e. if the voltage at the consumer does not drop to the threshold voltage within the set time. For this purpose, the checking unit preferably comprises a communication interface designed in a known manner and suitable for communication with the higher-level control unit.

In a preferred embodiment, the system according to the invention is designed to check several electronic fuses. In this case, the system according to the invention comprises at least one further consumer, at least one further electronic fuse which is arranged between the voltage source and one of the at least one further consumers, and at least one further voltage measuring device which is arranged to measure a voltage at one of the at least one further consumers. In this case, the checking unit is additionally set up to monitor the voltage at the at least one further consumer by means of the at least one further voltage measuring device, to switch the at least one further electronic fuse to non-conductive, and to check whether or not the voltage at the at least one further consumer drops to a threshold voltage within the set time. Preferably, the checking unit is also set up to provide an individual error signal to the higher-level control unit for each of the electronic fuses or to provide an error signal to the higher-level control unit that includes individual information for each of the electronic fuses.

One application of the invention is advantageously a vehicle, in particular an automobile. Advantageously, a vehicle with a system as described above is also suitable for achieving the above object. The system is used in a vehicle to secure the vehicle's own electrical system.

### BRIEF DESCRIPTION OF THE DRAWINGS

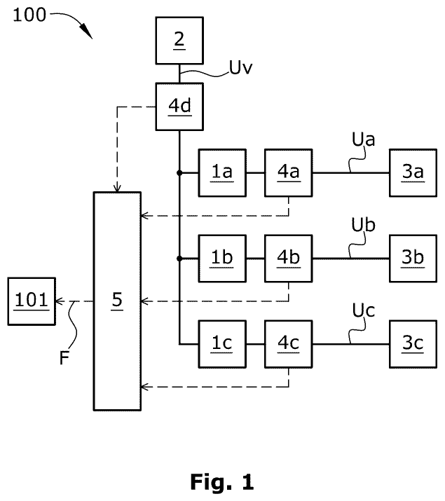

An embodiment of the present invention is described below with reference to the attached FIG. 1, which shows a schematic diagram of a system according to the invention for checking the switch-off capability of an electronic fuse.

### DETAILED DESCRIPTION OF THE CURRENT EMBODIMENT

FIG. 1 shows a system 100 according to the invention for checking the switch-off capability of three electronic fuses 1a-1c, by way of example.

The system 100 comprises a voltage source 2, which is set up in a known manner to provide a supply voltage Uv.

The system 100 further comprises three consumers 3a-3c, each of which is electrically connected to the voltage source 2.

The system 100 further comprises the three electronic fuses 1a-1c, wherein the first electronic fuse 1a is arranged to protect the first consumer 3a between the voltage source 2 and the first consumer 3a, wherein the second electronic fuse 1b is arranged to protect the second consumer 3b between the voltage source 2 and the second consumer 3b, and wherein the third electronic fuse 1c is arranged to protect the third consumer 3c between the voltage source 2 and the third consumer 3c.

The system 100 further comprises four voltage measuring devices 4a-4d, wherein the first voltage measuring device 4a is arranged to measure a voltage Ua at the first consumer 3a, wherein the second voltage measuring device 4b is arranged to measure a voltage Ub at the second consumer 3b, wherein the third voltage measuring device 4c is arranged to measure a voltage Uc at the third consumer 3c, and wherein the fourth voltage measuring device 4d is arranged to measure the supply voltage Uv.

The system 100 further comprises a checking unit 5, to which measured values of the four voltage measuring devices 4a-4d are provided, and which is set up to carry out a method according to the invention for checking the switch-off capability of the three electronic fuses 1a-1c.

In particular, the checking unit 5 is set up to monitor the voltages Ua-Uc at the consumers 3a-3c by means of the voltage measuring devices 4a-4c, to switch the three electronic fuses 1a-1c to non-conductive and to check whether the voltages Ua-Uc at the three consumers 3a-3c drop to a defined threshold voltage or not.

The threshold voltage can either be stored as an absolute voltage value in the checking unit 5 or can be determined by the checking unit 5 based on a voltage delta value stored in the checking unit 5 and the measured supply voltage Uv.

Furthermore, the same threshold voltage can be set for all three consumers 3a-3c, or individual threshold voltages can be set for the three consumers 3a-3c.

The checking unit 5 is also set up to reconnect the electronic fuses 1a-1c when the voltage Ua-Uc at the respective consumer 3a-3c has dropped to the respective threshold voltage or when a maximum test time has been reached since the respective electronic fuse 1a-1c was disconnected in order to avoid an interruption in the voltage supply to the consumers 3a-3c.

The checking unit 5 is also set up to monitor the voltage Ua-Uc at the respective consumer 3a-3c again if one of the electronic fuses 1a-1c has been switched to conductive again due to the maximum test time being reached, to switch the respective electronic fuse 1a-1c to non-conductive again and to check again whether the voltage Ua-Uc at the respective consumer 3a-3c drops to the threshold voltage within the set time or not.

The checking unit 5 is set up here to carry out a fixed number of renewed checks and then, if the voltage Ua-Uc at the respective consumer 3a-3c has not dropped to the threshold voltage within the set time during any of the checks, to provide an error signal F to a higher-level control unit 101, wherein the error signal F indicates at which of the three consumers 3a-3c the voltage Ua-Uc has not dropped to the threshold voltage within the set time, i.e. which of the three electronic fuses 1a-1c is faulty.

### List of Reference Numbers

100 system for checking the ability of an electronic fuse to switch off
1a-1c electronic fuses
2 voltage source
3a-3c consumers
4a-4d voltage measuring devices
5 checking unit
101 higher-level control unit
F error signal
Ua-Uc voltages at the consumers
Uv supply voltage

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for checking the ability to switch off an electronic fuse arranged between a voltage source and a consumer, comprising:
monitoring a voltage at the consumer while the electronic fuse is in a conductive state;
switching the electronic fuse to a non-conductive state; and
checking whether or not the voltage at the consumer drops to a threshold voltage within a predetermined time.

2. The method according to claim 1, further including returning the electronic fuse to the conductive state when the voltage at the consumer has dropped to the threshold voltage or when a maximum time has been reached since the electronic fuse has been switched to the non-conductive state.

3. The method according to claim 2, wherein, in response to the electronic fuse returning to the conductive state when the maximum time has been reached:
monitoring the voltage at the consumer;
switching the electronic fuse to the non-conductive state; and
checking whether or not the voltage at the consumer drops to the threshold voltage within the predetermined time.

4. A system for checking the ability to switch off an electronic fuse, comprising:
a voltage source;
a consumer;
an electronic fuse arranged between the voltage source and the consumer;
a voltage measuring device configured to measure a voltage at the consumer; and
a checking unit configured to:
monitor the voltage at the consumer via the voltage measuring device,
switch the electronic fuse to a non-conductive state, and
check whether or not the voltage at the consumer drops to a threshold voltage within a predetermined time.

5. The system according to claim 4, wherein the checking unit is further configured to provide an error signal to a higher-level control unit if the voltage at the consumer does not drop to the threshold voltage within the predetermined time.

6. The system according to claim 4, further comprising:
a second consumer;
a second electronic fuse arranged between the voltage source and the second consumer;
a second voltage measuring device configured to measure a voltage at the second consumer;
wherein the checking unit is further configured to:
monitor the voltage at the second consumer via the second voltage measuring device,
switch the second electronic fuse to a non-conductive state, and
check whether or not the voltage at the second consumer drops to a threshold voltage within the predetermined time.
